(19) United States
(12) Patent Application Publication
(10) Pub. No.: US 2008/0060582 A1
(43) Pub. Date: Mar. 13, 2008

(54) Actuated Animal Feeder

(76) Inventor: Robert J. Painter, Huntsville, AL (US)

Correspondence Address: LANIER FORD SHAVER & PAYNE P.C., P O BOX 2087, HUNTSVILLE, AL, 35804-2087, US

(21) Appl. No.: 11/941,743

(22) Filed: Nov. 16, 2007

Related U.S. Application Data
(62) Division of application No. 11/123,367, filed on May 6, 2005.

(51) Int. Cl. A01K 5/01

(52) U.S. Cl. 119/53.5

(57) ABSTRACT

A deer-actuated feeder is provided. The feeder has a storage compartment for the animal feed and an activation means which, when displaced, releases the feed through an opening in the storage compartment bottom. The activation means consist of a releasable plate which is held against the opening by either compression or tension forces.

### CROSS REFERENCE TO RELATED APPLICATION

This application is a divisional application under 35 U.S.C. § 121 of pending U.S. non-provisional application Ser. No. 11/123,367, filed May 6, 2005.

### FIELD OF THE INVENTION

The present invention relates generally to a demand-type animal feeding device. In particular, the present invention relates to a demand-type deer feeder. More particularly, the invention relates to a deer-actuated feeder.

### BACKGROUND OF THE INVENTION

Animal feeders are often used to provide an alternative source of food for animals. Such feeders can attract deer and other wild animals to the area where the feeders are installed to allow for viewing by landowners, photographers, and hunters. Most animal feeds, however, are subject to spoilage if exposed to the elements. Therefore, it is normally preferable to keep such feed in an enclosed container until such time as the animal desires to eat. Furthermore, it is often desirable to prevent smaller animals such as squirrels and raccoons from gaining access to the feed and diminishing the supply. The present invention provides a deer feeder which protects the feed from the elements, releases the feed at the direction of the deer, and prevents smaller animals from causing the release of the feed.

Many mechanical and electrical prior art animal feeders provide feed intermittently according to a pre-programmed time schedule. Such feeders, however, are expensive, are often battery operated, can be unreliable, and may require frequent maintenance. Furthermore, any animal is able to scavenge the feed from the vicinity of the feeder. Still other feeders must be hung from trees, which can make installation and refilling difficult to accomplish.

Therefore, it is the object of the present invention to provide an inexpensive, sturdy, reliable feeder which releases feed on demand by the intended recipient.

### SUMMARY OF THE INVENTION

The present disclosure is directed to a deer actuated feeder. This may be accomplished by providing a storage compartment for the feed, as well as an activation means whereby a deer or other large animal uses its hoof or nose to release a small amount of feed. The storage compartment can be any size or shape, has an opening in its bottom, and can store dry domestic animal feed such as corn, peanuts, grain, and other commercially available feed pellets.

The feed is released when a deer or other large animal of sufficient strength activates an activation means consisting of a releasable plate which covers the opening in the storage compartment bottom, extends beyond the outer periphery of the storage compartment, and is held against the opening by a tension of compression means such as a spring, a pneumatic closer, spring loaded hinge, bungee cord, rubber band, rubber block, or other similar device. Activating the activation means allows the dry feed to empty from the opening in the storage compartment bottom into a collection area of the plate or onto the ground for consumption by the deer. To limit the amount of food released, the activation means can consist of two plates, one to cover the opening and another that extends beyond the outer periphery of the storage compartment.

The feeder can be made of any material of appropriate strength and durability such as metal, high-density plastics, and other suitable materials, so long as such materials are able to withstand the elements (rain, ice, snow, heat, etc.) and agitation by the deer. The feeder should be suspended above the ground to allow the activation means to open sufficiently, and also to allow access by a deer's hoof. Such suspension can be achieved by a support means such as by attaching legs to the feeder or by attaching the mounting brackets of the feeder to a tree or other fixed, stable object.

As mentioned above, the activation means may be designed to allow only a small portion of feed to be released each time it is activated by a deer. This is also accomplished by limiting the size of the opening in the storage compartment bottom, and by using the appropriate tension to keep the releasable plate shut. Such tension may be maintained using any of the above listed tensions means in any one of several different locations, or on multiple locations, connected to the release plate. For example, one embodiment may have springs mounted on either side of the opening end of the release plate such that a downward force pulls the springs in tension and generates an upward force to cover the opening with the plate after the downward force has been removed. In an alternative embodiment, springs can be placed under the release plate against a fixed L-shaped ledge whereby the compressed spring maintains a constant upward force on the bottom of the release plate. In yet a third embodiment, a spring or multiple springs may be placed between two generally vertical flanges, one connected to the bottom of the storage compartment and the other connected to the bottom of the release plate whereupon activation by a deer compresses the spring(s) and generates an outward force against the flange causing the plate to cover the opening in the storage compartment.

The feeder can also include several storage compartments which are coupled together and have activation means attached to each storage compartment. This will allow different types of feed to be maintained and dispensed separately.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

These and other embodiments of the present invention will also become readily apparent to those skilled in the art from the following detailed description of the embodiments having reference to the attached figures, the invention not being limited to any particular embodiment(s) disclosed.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1A is perspective view of an exemplary embodiment of a demand-type animal feeder, in accordance with the present invention;

FIG. 1B is an expanded view of the activation means of the exemplary embodiment of the demand-type animal feeder;

FIG. 1C is a side view of the exemplary demand-type animal feeder depicted in FIGS. 1A and 1B with the activation means in its closed position;

FIG. 1D is a side view of the exemplary demand-type animal feeder depicted in FIGS. 1A and 1B with the activation means in its open position;

FIG. 2A is perspective view of an alternative embodiment of a demand-type animal feeder in accordance with the present invention;

FIG. 2B a side view of the demand-type animal feeder depicted in FIG. 2A with the activation means in its closed position;

FIG. 2C is a side view of the demand-type animal feeder depicted in FIGS. 2A and 2B with the activation means in its open position;

FIG. 3A is a perspective view of a third alternative embodiment of a demand-type animal feeder in accordance with the present invention;

FIG. 3B is a side view of the demand-type animal feeder depicted in FIG. 3A with the activation means in its closed position;

FIG. 3C is a side view of the demand-type animal feeder depicted in FIGS. 3A and 3B with the activation means in its open position.

FIG. 4 is a perspective view of a fourth alternative embodiment of a demand-type animal feeder in accordance with the present invention;

FIG. 5A is a perspective view of a fifth alternative embodiment of a demand-type animal feeder in accordance with the present invention when the activation means is in its close position.

FIG. 5B is a perspective view of a sixth alternative embodiment of a demand-type animal feeder in accordance with the present invention with the activation means in its open position.

### DETAILED DESCRIPTION

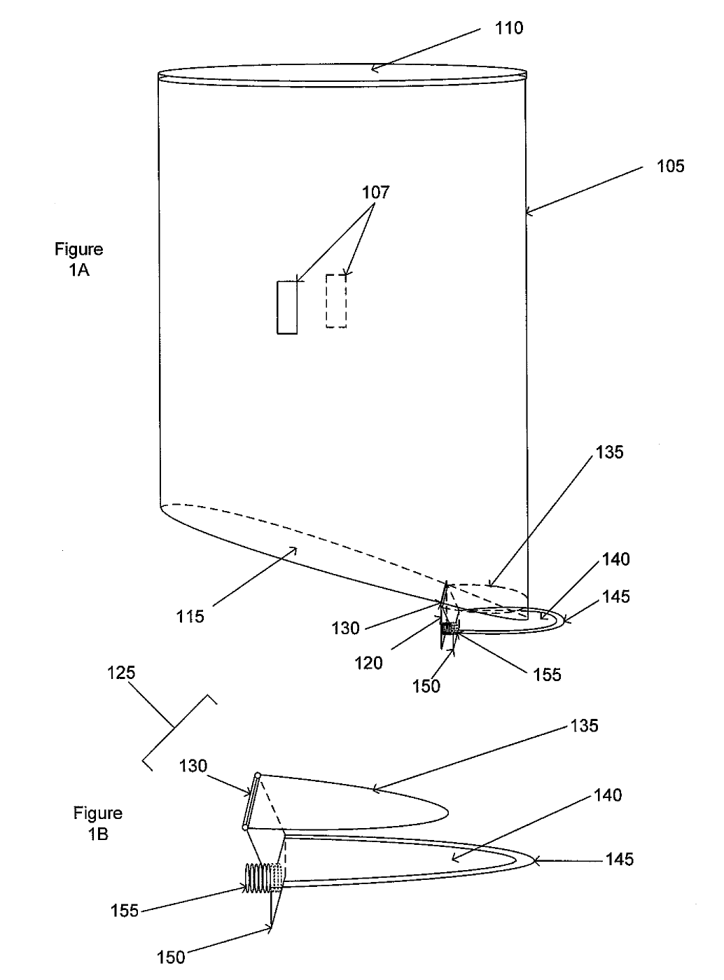

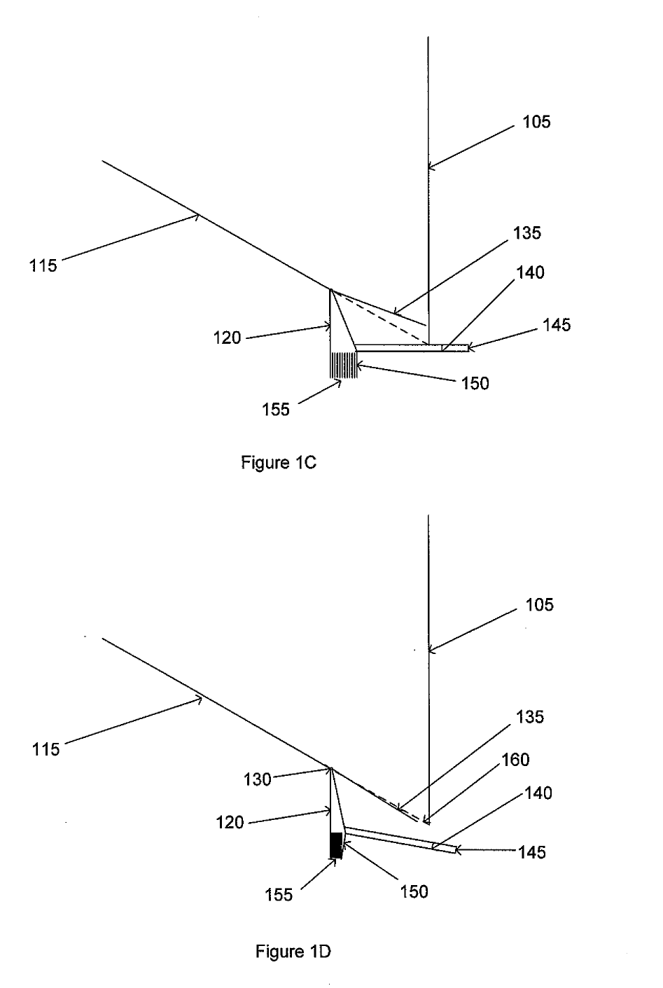

The various embodiments of the present invention and their advantages are best understood by referring to FIGS. 1-5 of the drawings. The elements of the drawings are not necessarily to scale, emphasis instead being placed upon clearly illustrating the principles of the invention. Throughout the drawings, like numerals are used for like and corresponding parts of the various drawings.

Referring now to FIG. 1A, a storage compartment 105 holds the animal feed and is covered by a top 110 in order to keep the feed dry. The storage compartment bottom 115 is angled so that gravity will ensure all feed is eventually released. The storage compartment has mounting brackets 107 to allow for attachment to a tree or other fixed object. The activation means 125 (FIG. 1B) contains a top plate 135 and a bottom plate 140 and is movably attached to the storage compartment bottom 115 by a hinge 130. The activation means 125 is held in an upright position, thus preventing the release of feed, by a spring 155 which is compressed between a generally vertical flange 120 that extends from the storage compartment bottom 115 and a second generally vertical flange 150 that extends from the bottom plate 140. The bottom plate 140 has a lip 145 that catches feed once it is released from the storage compartment 105. Feed is released when an animal of sufficient strength agitates the activation means by placing a downward force on the bottom plate 140 compressing the spring 155. As shown in FIG. 1D, this provides a small opening 160 from which the feed can exit the storage compartment 105.

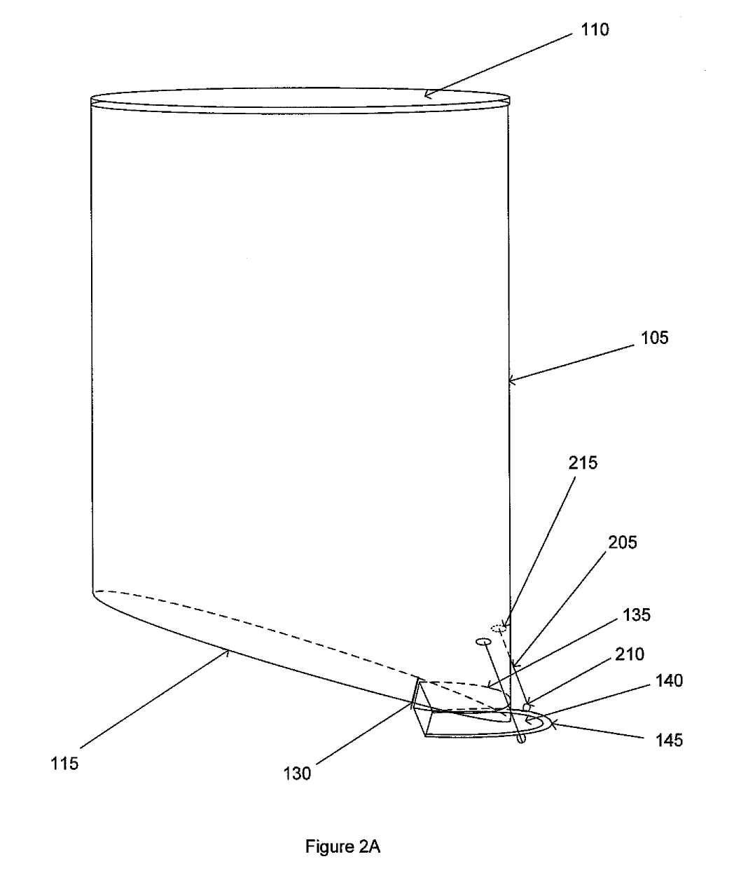

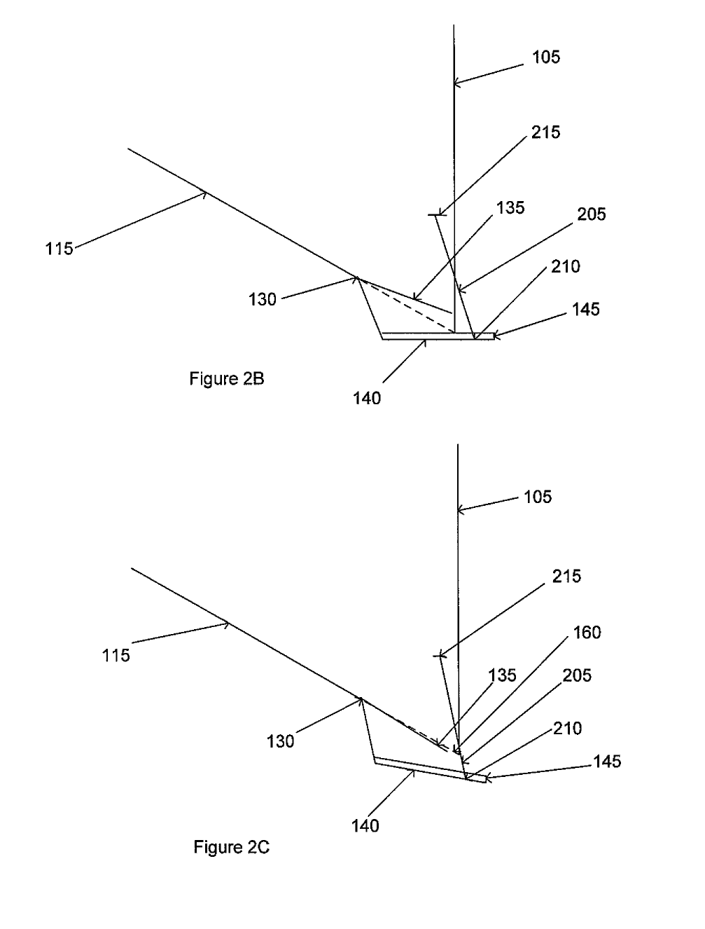

Alternatively, as shown in FIG. 2A, the activation means can be maintained in the closed position by tension means 205 affixed at a first end 215 to the storage compartment 105 and at a second end 210 to the bottom plate 140. FIG. 2B shows this alternative embodiment of the activation means in the closed position, and FIG. 2C shows the activation means in the open position.

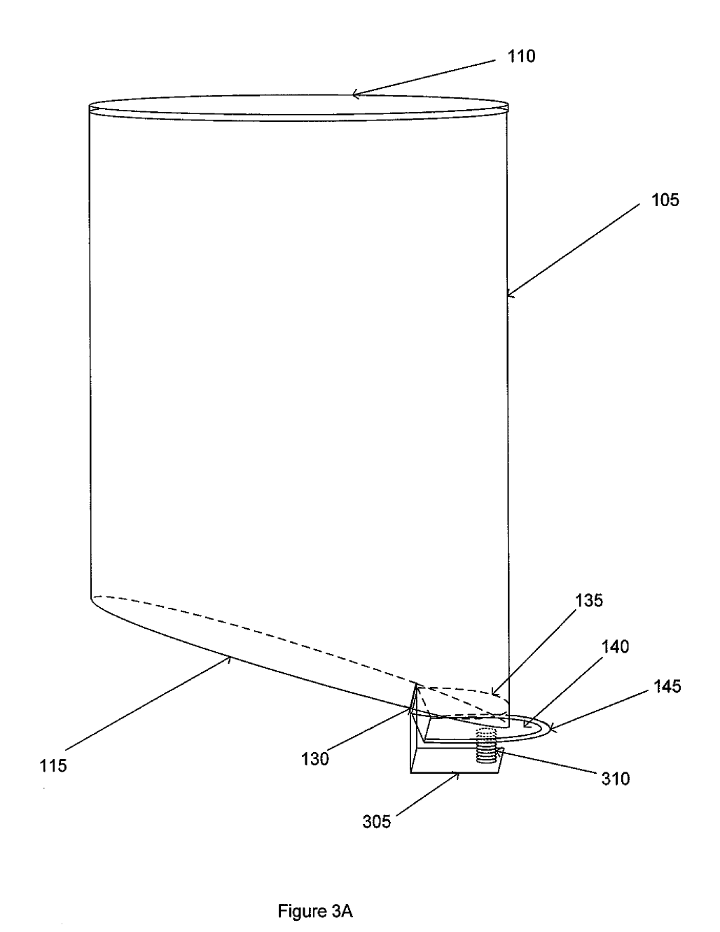

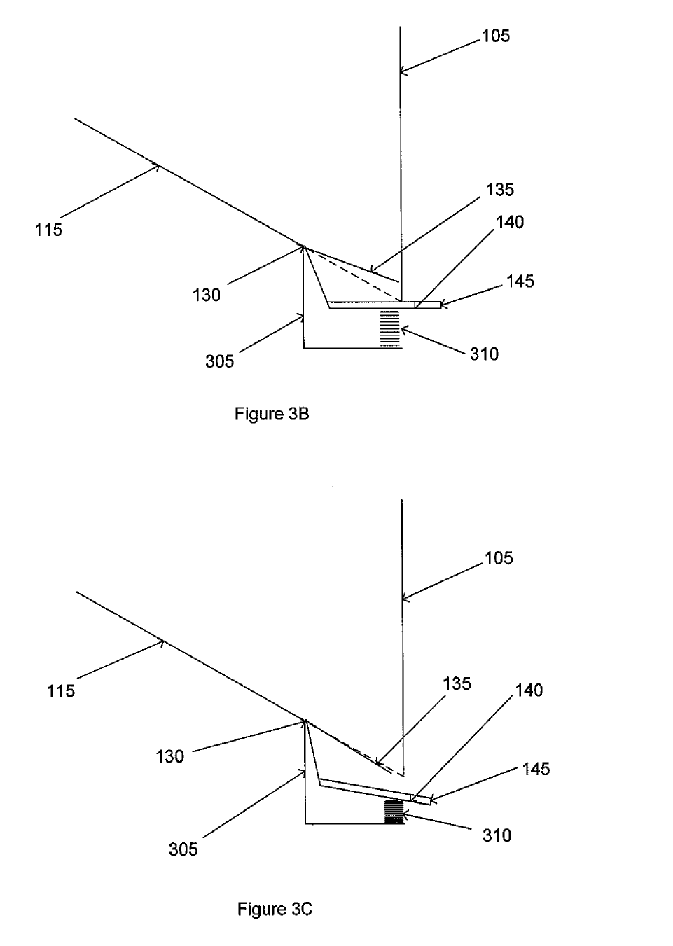

As best seen in FIG. 3A, in another alternative embodiment the activation means can be maintained in the closed position by a spring 310 compressed between the bottom plate 140 and a fixed L-shaped ledge 305 which is anchored to the storage compartment bottom 115. The activation means is activated and feed is allowed to exit the storage compartment when an animal of sufficient strength places a downward force on the bottom plate 140 which compresses the spring 310. The compressive force of the spring 310 causes the top plate 135 to cover the opening once the downward force has been removed, thereby blocking the further release of animal feed. FIG. 3B shows this alternative embodiment of the activation means in the closed position, and FIG. 3C shows the activation means in the open position.

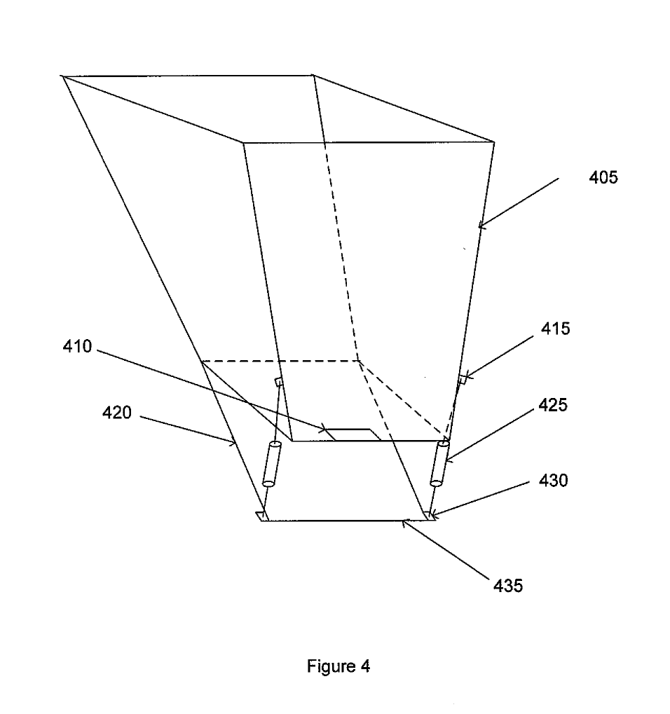

FIG. 4 shows the storage compartment 405 may be of any size or shape. Furthermore, the feed opening 410 which allows feed to exit when the release door 435 is in the open position can also be of any size or shape depending on the amount of feed desired to be released upon activation by an animal. In this particular embodiment, the tension means 425 comprise a pair of pneumatic closers attached on a first end 415 to the storage compartment 405 and at a second end 430 to the bottom plate 420.

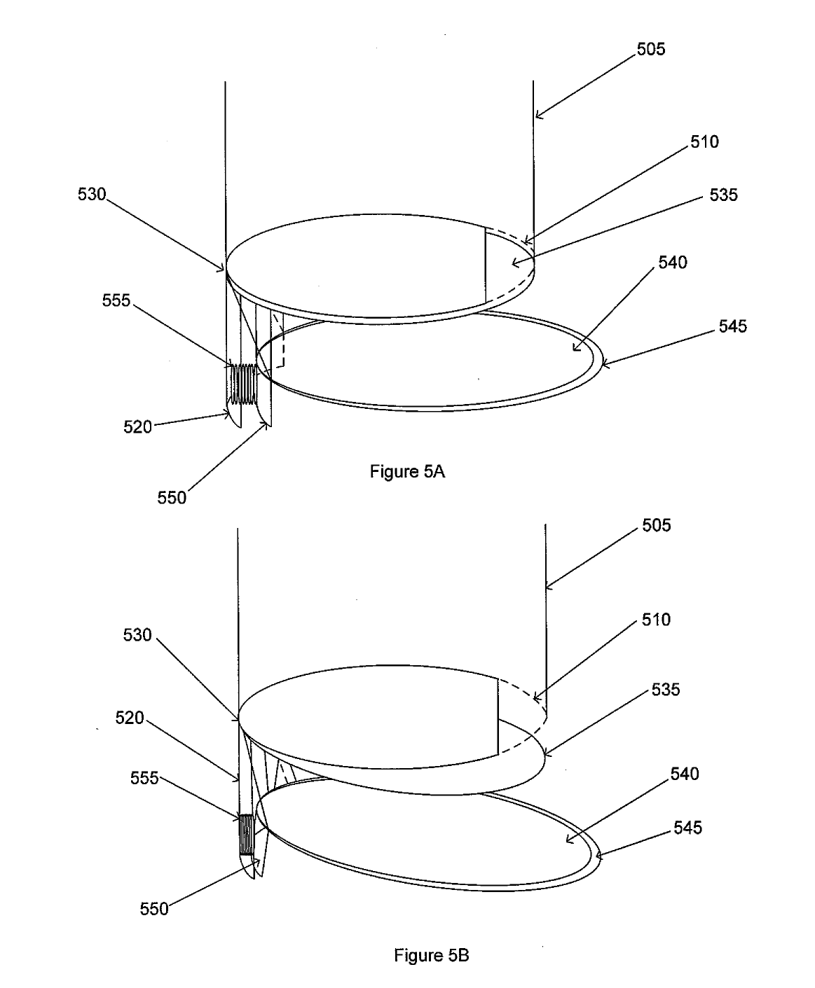

Finally, as shown in FIGS. 5A and 5B, the activation means can be pivotally attached by a hinge 530 at any point along the storage compartment bottom so long as sufficient forces can be maintained to cover the opening 510 in the storage compartment bottom 515 until activation by the animal. The activation means is activated when an animal of sufficient strength places a downward force on the bottom plate 540 thereby compressing the spring 555 between a flange 550 extending from the bottom plate 540 and a flange 520 extending from the storage compartment 505. The upper plate 535 which blocks the opening 510 (as best seen in FIG. 5A) is removed from the opening 510 by this downward force allowing feed to escape from the storage compartment 505.

This invention may be provided in other specific forms and embodiments without departing from the essential characteristics as described herein. The embodiments described above are to be considered in all aspects as illustrative only and not restrictive in any manner. The following claims rather than the foregoing description indicate the scope of the invention.

As described above and shown in the associated drawings, the present invention comprises an actuated deer feeder. While particular embodiments of the invention have been described, it will be understood, however, that the invention is not limited thereto, since modifications may be made by those skilled in the art, particularly in light of the foregoing teachings. It is, therefore, contemplated by the following claims to cover any such modifications that incorporate those features or those improvements that embody the spirit and scope of the present invention.

What is claimed is:

1. A demand-type feeder comprising:
a. a storage compartment having a generally slanted bottom, said bottom having an opening therein;
b. a plate biased against an outer surface of said bottom so as to cover said opening, said plate being pivotally affixed to said bottom and wherein said plate extends beyond the outer periphery of said container; and
c. an activation means mechanically coupled to said plate wherein displacement of said plate uncovers said opening.

2. The demand-type feeder of claim 1 further comprising a support means.

3. The demand-type feeder of claim 2 wherein said support means is a plurality of legs.

4. The demand-type feeder of claim 2 wherein said support means comprises mounting brackets suitable for securing said feeder to a generally vertical support.

5. The demand-type feeder of claim 1 wherein said activation means comprises:
a. a generally vertical L-shaped ledge affixed to said bottom at a point opposite said opening from an axis of rotation of said plate; and
b. a spring affixed to said L-shaped ledge wherein said spring biases said plate against an outer surface of said bottom.

6. The demand type feeder of claim 1 further comprising a removable top.

7. The demand type feeder of claim 1 wherein said plate has a lip about its outer perimeter to collect animal feed upon its release from said container.

8. A demand-type feeder comprising:
a. a storage compartment having a generally slanted bottom, said bottom having an opening therein;
b. a first plate substantially covering said opening and being pivotally affixed to said bottom along an axis of rotation;
c. a second plate substantially parallel and mechanically coupled to said first plate and wherein said plate extends beyond the outer periphery of said container; and
d. an activation means mechanically coupled to said second plate.

9. The demand-type feeder of claim 8 further comprising a support means.

10. The demand-type animal feeder of claim 9 wherein said support means is a plurality of legs.

11. The demand-type feeder of claim 9 wherein said support means comprises mounting brackets suitable for securing said feeder to a generally vertical support.

12. The demand-type feeder of claim 8 wherein said activation means comprises:
a. a generally vertical L-shaped ledge affixed to said bottom at a point opposite said opening from said first plate's axis of rotation; and
b. a spring affixed at a first end to said ledge and acting upon said second plate.

13. The demand-type feeder of claim 8 further comprising a removable top.

14. The demand-type feeder of claim 8 wherein said second plate has a lip about its outer perimeter to collect animal feed upon displacement of said second plate.

15. A demand-type feeder comprising:
a. a plurality of storage compartments each having a generally slanted bottom, wherein each of said respective storage compartment bottoms are slanted toward the outer periphery of said feeder and wherein each of said respective storage compartment bottoms has an opening therein; and
b. a plurality of plates equal in number to said plurality of said storage compartments, wherein a respective one of said plates is associated with a respective one of said storage compartments and wherein said plate substantially covers said opening with which it is associated;
c. wherein each of said plates is pivotally affixed to the respective bottom of the storage compartment with which it is associated;
d. a plurality of activation means equal in number to said plurality of storage compartments, wherein a respective one of said activation means is associated with a respective one of said plates and wherein each of said activation means is mechanically coupled to the plate with which it is associated and wherein said activation means serves to bias said plate to substantially cover the opening with which said plate is associated.
